(19) United States
(12) Patent Application Publication
(10) Pub. No.: US 2018/0245716 A1
(43) Pub. Date: Aug. 30, 2018

(54) CONDUIT CLIP

(71) Applicant: J. van Walraven Holding B.V., Mijdrecht (NL)

(72) Inventors: Frank Nijdam, Zeewolde (NL); Robert van der Mik, Loenen aan de Vecht (NL)

(21) Appl. No.: 15/757,011

(22) PCT Filed: Sep. 5, 2016
(86) PCT No.: PCT/NL2016/050616

§ 371 Date: Mar. 2, 2018

(30) Foreign Application Priority Data
Sep. 7, 2015 (NL) 2015404

(51) Int. Cl. F16L 3/24; H02G 3/04; F16B 2/24; F16L 3/13

(52) U.S. Cl. CPC F16L 3/24; H02G 3/0456; F16L 3/1211; F16L 3/13; F16B 2/246

(57) ABSTRACT

A one-piece conduit clip made of spring steel sheet material includes an elongate anchor plate for coupling to a channel member having a longitudinal slot defined between two flanges. The clip includes two opposing arms interconnected by the anchor plate. The arms include a holding portion remote from the anchor plate to hold the conduit. A closure portion extends from an end of the holding portion. Between a lower end of the holding portion and each axial end part of the anchor plate an accommodation space is defined for a flange of the channel member when the anchor plate extends at an angle relative to the longitudinal slot. The anchor plate has resilient lugs at its axial end parts adapted to engage the flanges so as to pull the lower end of the holding portion into engagement with an upper side of the flanges.

### CROSS-REFERENCE TO RELATED APPLICATIONS

This application is the National Stage of International Application No. PCT/NL2016/050616, filed Sep. 5, 2016, which claims the benefit of Netherlands Application No. NL 2015404, filed Sep. 7, 2015, the contents of which is incorporated by reference herein.

### FIELD OF THE INVENTION

The invention relates to a one-piece conduit clip comprising: an elongate anchor plate for coupling the conduit clip to a channel member having a longitudinal slot defined between two inwardly extending flanges, wherein the anchor plate has axial end portions, and two opposing arms interconnected by the anchor plate, wherein the arms each comprise a holding portion remote from the anchor plate to hold the conduit, and a closure portion extending from an end of the holding portion and having a connector element to mutually connect the two closure portions in a closed state of the conduit clip. Between a lower end of the holding portion and each axial end part of the anchor plate an accommodation space is defined which is accessible from the side. Each accommodation space is for the accommodation of a flange of the channel member in a pre-assembly state, wherein—in use—the anchor plate can be aligned with the longitudinal slot and the anchor plate can be inserted through the longitudinal slot into the channel member, in such a way that subsequently after turning of the conduit clip, preferably a quarter turn, the anchor plate—in said pre-assembly state—extends at an angle, preferably substantially at right angles, relative to the longitudinal slot, so that the flanges are situated in the accommodation spaces.

### BACKGROUND OF THE INVENTION

A clip of this type is known from U.S. Pat. No. 2,375,513. This known pipe hanger has an anchor plate with a central hole and upstanding side portions. The flanges of the channel member are in use accommodated between the edges of the side portions and a curved holding portion. At the other end the conduit clip has two opposing end flanges provided with through holes. A threaded bolt extends through the holes in the flanges to close the conduit clip and to draw the flanges together.

The invention has for an object to provide a conduit clip that is suitable to attach lighter conduit structures such as electrical cables or the like to a channel member, in particular a channel member that has a slot with inwardly folded flanges and is known in the art as a “strut rail”.

### SUMMARY OF THE INVENTION

This object is achieved by a one-piece conduit clip comprising:
an elongate anchor plate for coupling the conduit clip to a channel member having a longitudinal slot defined between two inwardly extending flanges, wherein the anchor plate has axial end portions,
two opposing arms interconnected by the anchor plate, wherein the arms each comprise a holding portion remote from the anchor plate to hold the conduit, and a closure portion extending from an end of the holding portion and having a connector element to mutually connect the two closure portions in a closed state of the conduit clip,
wherein between a lower end of the holding portion and each axial end part of the anchor plate an accommodation space is defined which is accessible from the side, each accommodation space being for the accommodation of a flange of the channel member in a pre-assembly state, wherein—in use—the anchor plate can be aligned with the longitudinal slot and the anchor plate can be inserted through the longitudinal slot into the channel member, in such a way that subsequently after turning of the conduit clip, preferably a quarter turn, the anchor plate—in said pre-assembly state—extends at an angle, preferably substantially at right angles, relative to the longitudinal slot, so that the flanges are situated in the accommodation spaces,
wherein the anchor plate, at its axial end parts, has resilient lugs adapted to engage the flanges inside the channel member so as to pull the lower end of the holding portion into engagement with an upper side of the flanges, and
wherein the one-piece conduit clip is made of spring steel sheet material.

The action of the resilient lugs pulls the lower end of the holding portion into engagement with the upper side of the flanges in an opens state of the conduit clip with a force that still allows adjustment of the position of the clip on the channel member. In other words the clip can still be moved along the channel member in the longitudinal direction by a fitter. If no force is applied the clip is retained in its pre-mounting position on the channel member.

The one-piece conduit clip is made of spring steel sheet material. Because the conduit clip is made for relatively light conduit types, the clip can be made of relatively thin spring steel. The sheet material is cut and bent in the desired shape, and the spring steel sheet material provides a resilient property to the conduit clip such that it can be manually opened and closed by the user. Furthermore it provides the resiliency to the resilient lug.

In another possible embodiment, not forming part of the present invention, the one-piece conduit clip is made of plastics material. Plastics material can also provide the required resiliency in the clip for proper functioning. The plastic clip can be made by injection moulding.

It is noted that “conduit” herein is meant to comprise (electrical) cable, plastic pipe, metal pipe and other cylindrical and/or tubular members.

In a further embodiment the resilient lug is formed as a tongue with a bent-up end portion. The tongue is easy to manufacture and the bent up end portion engages on the edge of the folded in flange.

In a particular further embodiment the tongue is defined by a through slit in the axial end portion of the anchor plate extending from a longitudinal edge in a transverse direction.

In a further embodiment the through slit extends over approximately one third of the width of the anchor plate. The width of the anchor plate is related to the width of the slot in the “strut rail”-type channel member. This slot width may be standardized. The length of the cut determines the length of the tongue and its stiffness. It was found that one third of the width of the anchor plate suitable for strut rails provides sufficient stiffness.

In yet a further embodiment of the conduit clip the anchor plate has one or more reinforcement regions. In a particular embodiment this reinforcement region is a raised region(s) with respect to an anchor plate upper surface. Such a raised region provides an increased stiffness to the otherwise flat anchor plate.

The anchor plate may have one central reinforcement region, but may also have multiple reinforcements regions.

In a particular embodiment of the conduit clip each closure portion generally has an L-shape, wherein the end portions of the L-shape extend towards each other and in a closed shape overlap each other at least partially. This shape provides that connector elements other than threaded bolts or screws can be more easily used to connect the closure portion of the conduit clip.

In a particular embodiment one or more hooking lugs and one or more corresponding holes may be provided as connector elements to connect the end portions of the closure portions. More in particular the end portion of one of the closure portions may be provided with two slotted holes, and the end portion of the other one of the closure portions may be provided with two hook shaped bent lateral edges. The holes and the hook shaped bent lateral edges can be easily formed out of the sheet material used for the conduit clip.

In another possible embodiment the connector element is a fastener with a threaded shank, such as a screw, wherein the closure portion comprises a flange with a hole or bore through which the shank extends in the closed state of the clip.

In a possible embodiment of the conduit clip a weakening cut-out is provided at a transition bend from the holding portion to the closure portion to ease closing of the conduit clip. By providing said cut-out the cross sectional area is decreased at the transition bend whereby the stiffness of the conduit clip at said bend is reduced, which allows easier introduction of the conduit in the conduit clip and closing of the conduit clip.

In a further embodiment at each of the weakening cut-outs a barb is formed, which constitutes an extension of the closure portion. The barbs form a stop support for a conduit received in the conduit clip in an open state, such that the conduit is retained in the holding portion and cannot move beyond the transition bend out of the holding portion under its own weight.

In the open state of the conduit clip the barbs allow sliding of the conduit through the conduit clip for adjustment. In the closed state of the conduit clip the barbs engage harder on the conduit and prevent sliding movements of the conduit through the conduit clip. Furthermore in some embodiments the barbs will force the conduit into engagement with the upper side of the flanges of the channel member.

The invention will be elucidated further in the following description with reference to the drawings.

### BRIEF DESCRIPTION OF THE DRAWINGS

FIG. 1 shows a view in perspective of a preferred embodiment of a conduit clip according to the invention in an open state;

FIG. 2 shows a lower portion of the conduit clip of FIG. 1, from a slightly other angle as in FIG. 1;

FIG. 3 shows an upper portion of the conduit clip of FIG. 1, from a slightly other angle as in FIG. 1;

FIGS. 4A-4D show how the conduit clip of FIG. 1 is mounted to a channel member;

FIGS. 5A and 5B show how a conduit is fitted in the conduit clip;

FIG. 6 shows how a conduit is suspended from the conduit clip in an open state;

FIG. 7 shows a detail of the conduit clip as it is shown in FIG. 6; and

FIG. 8 shows a view in perspective of another possible embodiment of a conduit clip according to the invention in an open state.

### DETAILED DESCRIPTION OF THE INVENTION

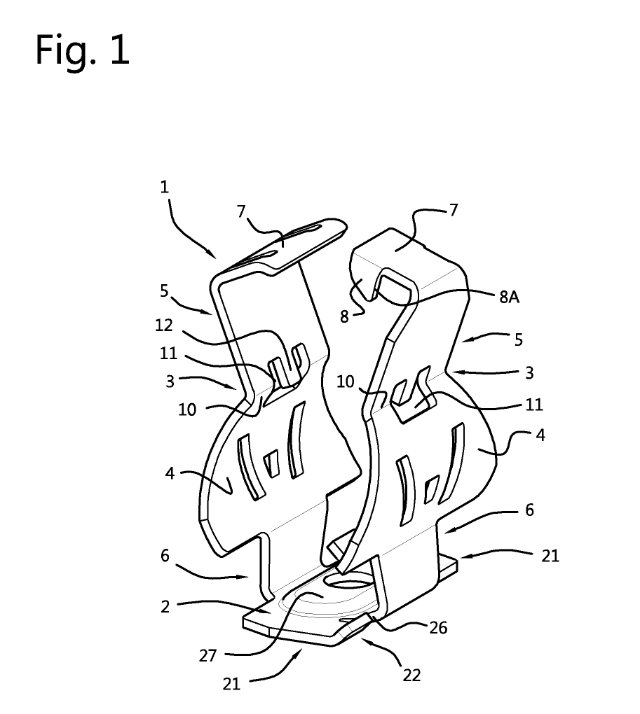

FIG. 1 shows a conduit clip 1 which is made in one piece from sheet metal by bending and cutting. In particular the conduit clip 1 is made of spring steel.

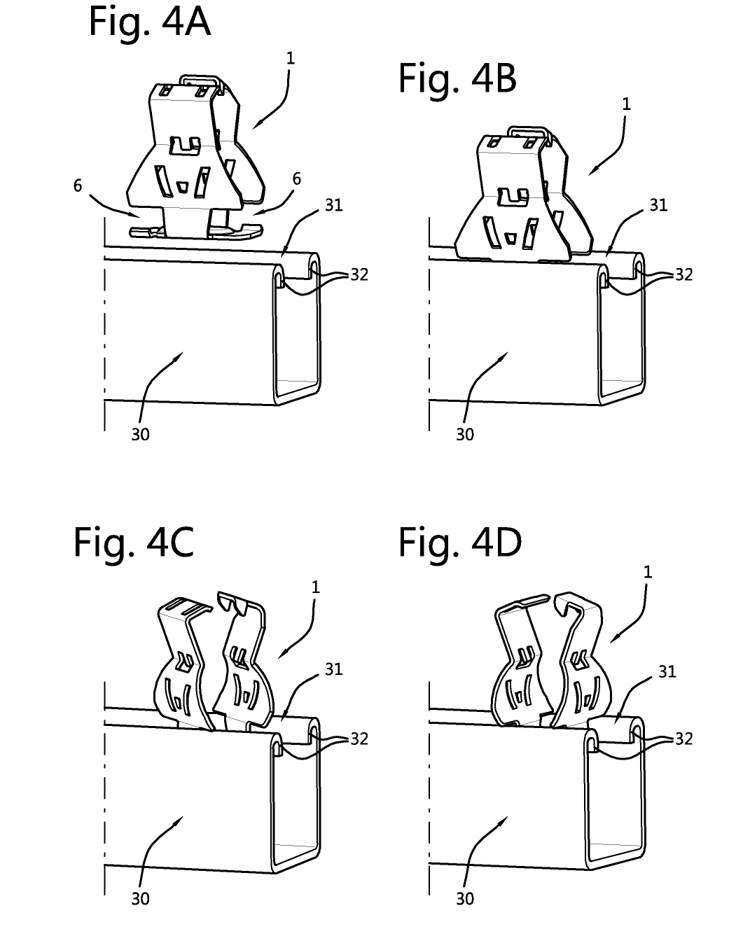

The conduit clip 1 has an elongate anchor plate 2 which is adapted to couple the conduit clip 1 to a channel member 30 having a longitudinal slot 31 defined between two inwardly extending flanges 32, as will be shown in FIGS. 4A-4D. In particular the flanges 32 are inwardly folded flanges (see FIGS. 4A-4D), which are typical for channel members of the “strut rail” type. The anchor plate 2 has axial end portions 21.

It is noted that a “strut rail” is a profiled section element which has generally a C-shaped cross section with a bottom and two lateral walls. From either lateral walls flanges extend towards each other which define between them a longitudinal slot. Typical for a “strut rail” is that the flanges are bent inwards such that the ends of the flanges are directed towards the bottom of the profiled section element as can be seen in FIGS. 4A-4D.

The conduit clip 1 furthermore has two opposing arms 3 interconnected by the anchor plate 2. The arms 3 each comprise a holding portion 4 remote from the anchor plate 2 to hold the conduit 40. The holding portions 4 are curved to conform to the outer surface of the conduit 40 to be held. The arms 3 also include a closure portion 5 extending from an upper end of the holding portion 4. The closure portion 5 is adapted to mutually lock the arms 3 in a closed state of the conduit clip 1.

At a transition bend 10 from the holding portion 4 to the closure portion 5 a weakening cut-out 11 is provided to ease closing of the conduit clip 1.

Between a lower end of the holding portion 4 and each axial end part 21 of the anchor plate 2 an accommodation space 6 is defined which is accessible from the side. Each accommodation space 6 is adapted to accommodate a portion of a flange 32 of the channel member 30 in a pre-assembly state. In use—the anchoring plate 2 can be aligned with the longitudinal slot 31 (cf. FIG. 4A) and the anchoring plate 2 can be inserted through the longitudinal slot 31 into the channel member (cf. FIG. 4B). Subsequently the conduit clip 1 can be turned, in the particular embodiment a quarter turn (cf. FIGS. 4C and 4D). The anchor plate 2—in said pre-assembly state (FIG. 4D)—extends at right angles relative to the longitudinal slot 31, so that the flanges 32 are situated in the accommodation spaces 6.

The anchor plate 2 has at its axial end parts 21 resilient lugs 22 adapted to engage the flanges 32 inside the channel member 30 so as to pull the lower end of the holding portion 4 into engagement with an upper side of the flanges 32.

The resilient lug 22 is formed as a tongue 23 with a bent-up end portion 24. The tongue 23 is defined by a through slit 25 in the axial end portion 21 of the anchor plate 2. The through slit 25 extends from a longitudinal edge 26 in a transverse direction. In the example shown the through slit 25 extends over approximately one third (⅓) of the width of the anchor plate 2.

The anchor plate 2 in the shown embodiment has one central reinforcement region 27 formed in it. In other embodiments more reinforcement regions could be formed. The reinforcement region 27 is formed by forming a depression from an underside of the anchor plate 2 such that at an upper side a raised region results.

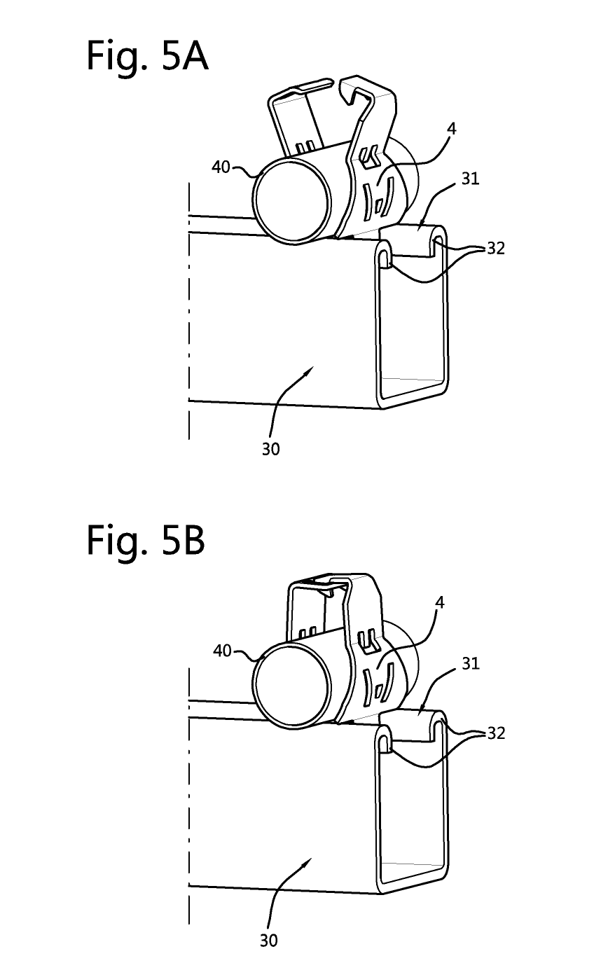

Each closure portion 5 generally has an L-shape, wherein the end portions 7 of the L-shape extend towards each other and in a closed shape overlap each other at least partially (cf. FIG. 5B. Hooking lugs 8 are provided on one end portion 7 formed as two hook shaped bent lateral edges of the end portion. In the other end portion 7 corresponding holes in the form of slots 9 are formed (cf. FIG. 3). By inserting the hooking lugs 8 in the slots 9 the end portions 7 of the closure portions 5 are connected such that the conduit clip 1 is maintained in the closed state as is shown in FIG. 5B.

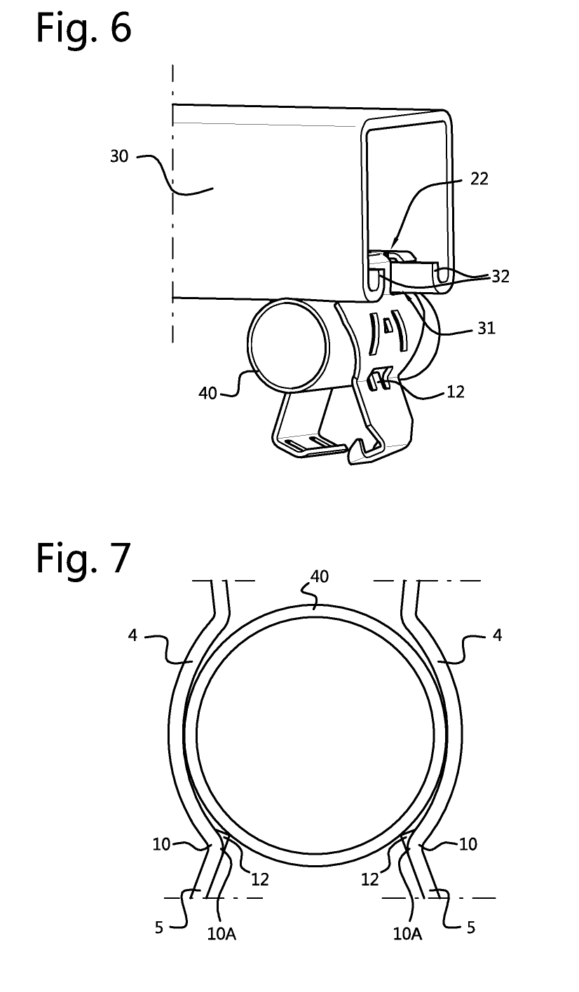

At each of the weakening cut-outs 11 at the transition bend 10 a barb 12 is formed. The barb 12 constitutes an extension of the closure portion 5. The barbs 12 formed on the opposite closure portions 5 form a stop support for a conduit 40 received in the conduit clip 1 in an open state as is shown in FIGS. 6 and 7. The conduit 40 is retained in the holding portion 4 and cannot move beyond the transition bend 10 out of the holding portion 4 under its own weight. If the barbs 12 were not present the conduit 40 would engage the rounded edge 10A at the transition bend 10 whereby a force component would result that would spread the arms 3 whereby the conduit 40 could get disengaged from the conduit clip 1.

The hook shape of the hooking lugs 8 and the shape of the corresponding slots 9 is preferably such that if the fitter pushes on the closure portion 5 provided with the slots 9, the closure portions 5 are released from each other. Due to the resiliency of the clip the arms 3 tend to spread if they are not coupled to each other by the lugs 8 and slots 9. This provides an “easy opening” feature to the clip, which allows easy opening of the clip without the necessity to use tools.

The barbs 12 enhance this spreading of the arms 3. The barbs 12 push on the conduit 40 in the closed state of the clip 1, whereby the clip 1 elastically deforms at the barbs 12 and possibly adjacent the barbs 12. The mentioned elastic deformation generates a reaction force which attempts to spread the arms 3 apart. This increased spreading force keeps the hooking lugs 8 and the corresponding slots 9 in a tight engagement. When the closure portion with the slots 9 is pushed inwards, the engagement between the hooking surface 8A of the hooking lug 8 and the edge of the slot 9 is lost and due to the increased spreading force the lugs 8 flip out of the slots 9 and the clip 1 opens.

A hooking lug 8 with a hooking surface 8A that is perpendicular to the substantially flat end portion 7 of the closure portion 5 is well adapted to provide the easy opening feature. If there would be a sharp angle (angle smaller than 90°) between the hooking surface 8A and the end portion 7, the clip 1 will be more difficult to open, and a tool may be necessary. If the angle would be an obtuse angle (angle greater than 90°), a secure closure of the clip could not be assured.

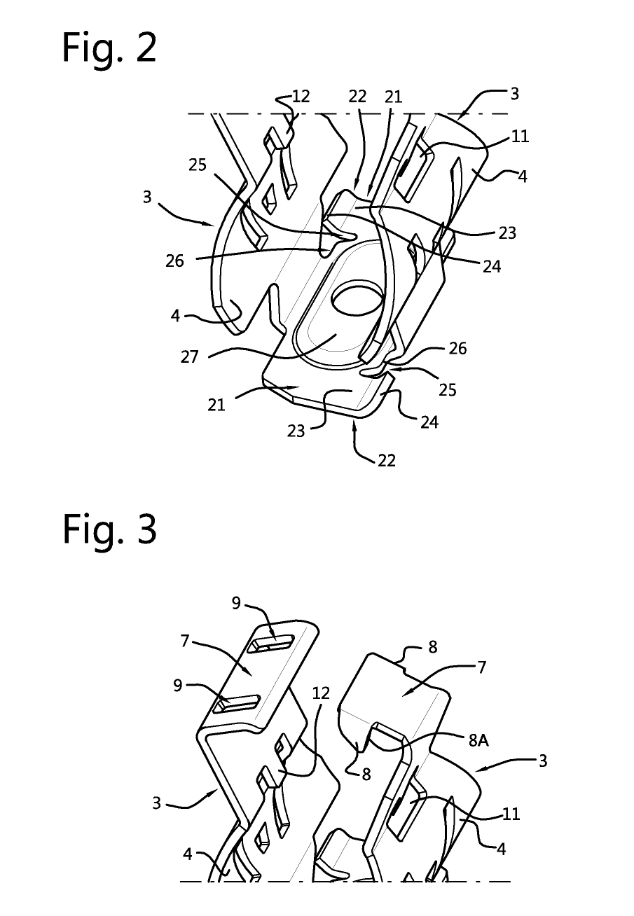

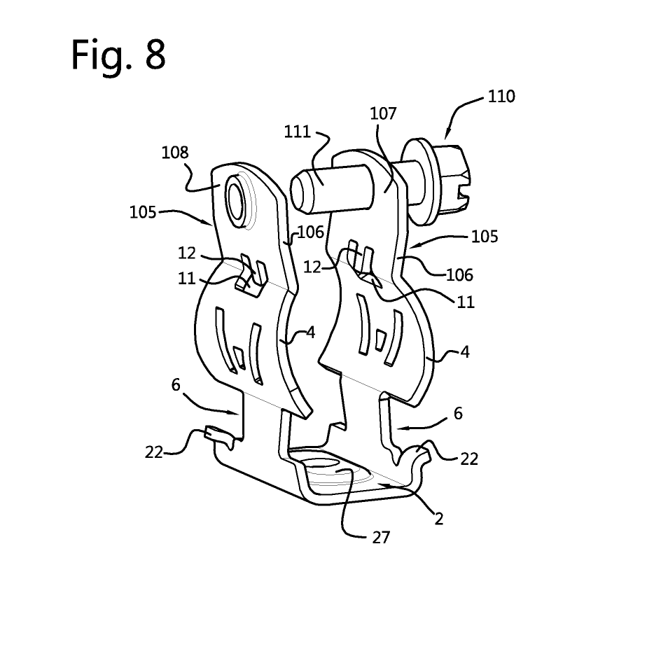

FIG. 8 shows a conduit clip 101 which is made in one piece from sheet metal by bending and cutting. In particular the conduit clip 1 is made of spring steel. The conduit clip 101 has generally the same anchor portion 2 and holding portions 4 as the embodiment of FIG. 1. The same parts of those portions 2, 4 are therefore indicated by the same reference numerals, and for a description of those parts is referred to the above description referring to FIGS. 1-7. The difference between the conduit clip 101 of FIG. 8 and the conduit clip of FIG. 1 lies in the closure portion of the clip.

In FIG. 8 the closure portions are indicated by reference numeral 105. The respective closure portions 105 extend from an upper end of the corresponding holding portions 4. The closure portions 105 have a proximal portion 106 that adjoins the holding portion 4 at one end. The closure portion 105 furthermore has a flange portion 107 and 108 respectively, which respective flange portions 107, 108 adjoin the proximal portion 106 under a slight angle with respect to the proximal portion of the closure portion 105.

The flange portions 107 and 108 can be connected by a screw 110. Thereto, in the shown embodiment, the flange portion 107 is provided with a hole through which a screw shank 111 can extend and the opposing flange portion 108 is provided with a threaded bore, which can cooperate with the threaded shank 111 of the screw 110 such that the flange portions 107 and 108 can be tightened towards each other.

Instead of a screw 110 also a bolt and nut or other pin-type fastening elements could be applied to mutually connect the flanges and tighten the clip around the conduit.

1. A one-piece conduit clip comprising:
an elongate anchor plate for coupling the conduit clip to a channel member having a longitudinal slot defined between two inwardly extending flanges, wherein the anchor plate has axial end portions, and
two opposing arms interconnected by the anchor plate, wherein the arms each comprise a holding portion remote from the anchor plate to hold the conduit, and a closure portion extending from an end of the holding portion and having a connector element to mutually connect the two closure portions in a closed state of the conduit clip,
wherein between a lower end of the holding portion and each axial end part of the anchor plate an accommodation space is defined which is accessible from the side, each accommodation space being for the accommodation of a flange of the channel member in a pre-assembly state, wherein—in use—the anchor plate can be aligned with the longitudinal slot and the anchor plate can be inserted through the longitudinal slot into the channel member, in such a way that subsequently after turning of the conduit clip, the anchor plate—in said pre-assembly state—extends at an angle, relative to the longitudinal slot, so that the flanges are situated in the accommodation spaces,
wherein the anchor plate, at its axial end parts, has resilient lugs adapted to engage the flanges inside the channel member so as to pull the lower end of the holding portion into engagement with an upper side of the flanges, and
wherein the one-piece conduit clip is made of spring steel sheet material.

2. The conduit clip according to claim 1, wherein the resilient lug is formed as a tongue with a bent-up end portion.

3. The conduit clip according to claim 2, wherein the tongue is defined by a through slit in the axial end portion of the anchor plate extending from a longitudinal edge in a transverse direction.

4. The conduit clip according to claim 3, wherein the through slit extends over approximately one third of the width of the anchor plate.

5. The conduit clip according to claim 1, wherein the anchor plate has at least one reinforcement region.

6. The conduit clip according to claim 5, wherein the conduit clip has one central reinforcement region.

7. The conduit clip according to claim 5, wherein the at least one reinforcement region is a raised region with respect to an anchor plate upper surface.

8. The conduit clip according to claim 1, wherein each closure portion generally has an L-shape, wherein the end portions of the L-shape extend towards each other and in a closed shape overlap each other at least partially.

9. The conduit clip according to claim 8, wherein at least one hooking lug and at least one corresponding hole is provided to connect the end portions of the closure portions.

10. The conduit clip according to claim 9, wherein the end portion of one of the closure portions is provided with two slotted holes, and wherein the end portion of the other one of the closure portions is provided with two hook shaped bent lateral edges.

11. The conduit clip according to claim 9, wherein the at least one hooking lug has a hook shape and the at least one corresponding hole has a shape such that if in use in the closed state of the conduit clip, a person pushes on the closure portion provided with the at least one hole, the closure portions are released from each other.

12. The conduit clip according to claim 1, wherein at a transition bend from the holding portion to the closure portion a weakening cut-out is provided to ease closing of the conduit clip.

13. The conduit clip according to claim 12, wherein at each of the weakening cut-outs a barb is formed, which constitutes an extension of the closure portion, said barbs forming a stop support for a conduit received in the conduit clip in an open state, such that the conduit is retained in the holding portion and cannot move beyond the transition bend out of the holding portion under its own weight.

14. The conduit clip according to claim 1, wherein the connector element is a fastener with a threaded shank, and wherein the closure portion comprises a flange with a hole or bore through which the shank extends in the closed state of the clip.
